(19) United States
(12) Patent Application Publication
(10) Pub. No.: US 2016/0136051 A1
(43) Pub. Date: May 19, 2016

(54) VIAL AND SYRINGE ADAPTORS AND SYSTEMS USING SAME

(71) Applicant: VAPO-Q CLOSED SYSTEMS LTD., Tel-Aviv (IL)

(72) Inventor: Gilad LAVI, Rishion-Lezion (IL)

(21) Appl. No.: 14/889,852

(22) PCT Filed: May 14, 2014
(86) PCT No.: PCT/IL14/50425

§ 371 Date: Nov. 8, 2015

Related U.S. Application Data
(60) Provisional application No. 61/825,147, filed on May 20, 2013.

(51) Int. Cl. A61J 1/20; A61J 1/22

(52) U.S. Cl. CPC A61J 1/2072; A61J 1/22; A61J 1/2096

(57) ABSTRACT

Adaptors for use with a vial and/or syringe are disclosed. The adaptors include fluid conduits for connecting the vial to an external port and/or to a syringe. The vial adaptor includes conduits for enabling outflow of gasses from the vial into a pliable reservoir while the syringe adaptor includes a conduit and reservoir for trapping residual liquids following removal of syringe.

### FIELD AND BACKGROUND OF THE INVENTION

The present invention relates to systems and methods for maintaining equal pressure inside medication in-vial pressure equilibrium when withdrawing or injecting medication as well as to as to a connector for safe transfer of drugs Medicaments are often supplied in dry or lyophilized form and thus must be reconstituted prior to use by adding diluent. Such medicaments are typically supplied in glass vials fitted with a rubber septum. The diluent is typically introduced into the vial via a sharpened cannula, which is forced through the rubber septum. Following reconstitution, the liquid medicament is withdrawn via a syringe and administered to the patient.

Such reconstitution of dry medicaments can expose the medicament to contaminants and more importantly, it can lead to contamination of the environment by the drug.

The latter can be caused by pressure differentials in the drug vial which can lead to the escape of vapors, aerosol or drops to the environment or by contamination of drug residuals on the external surface of the septum, syringe needle or Luer lock.

Drug contamination of the environment, especially by hazardous drugs such as antineoplastic drugs and immunosuppressants, can lead to acute and short term reactions as well as long term reactions among nurses, pharmacists and pharmacy technicians. Occupational exposure can lead to skin-related and ocular effects, flu-like symptoms, sore throat, chronic cough infections, dizziness, eye irritation and headache, fetal abnormalities, fetal loss, and fertility impairment as well as increased chances of developing cancer.

Health care workers who handle hazardous drugs utilize personnel protective equipment (PPE) such as protective clothing, respirators and biological safety cabinets. The use of Closed drug transfer devices (CSDT) in conjunction with other safety measures is a proven way to increase safety levels when preparing and administrating hazardous drugs. Closed drug transfer devices (CSTD) can mechanically prevent the transfer of environmental contaminants into the system and the escape of drug and vapor out of the system.

Although CTSDs are known, there is still a need for vial adaptors, which are safe, affordable, not prone to operational errors and capable of effectively dealing with under- and over-pressure in the vial.

### SUMMARY OF THE INVENTION

According to one aspect of the present invention there is provided a device for compensating for pressure changes in a vial comprising: (a) a first conduit for fluidly connecting the vial to an external port; (b) a second conduit for enabling outflow of gasses from the vial, the second conduit having a valve for preventing outflow of liquid from the vial through the second lumen; and (c) a pliable reservoir being fluidly connected to the second conduit and having an expanded volume larger than a fluid volume of the vial.

According to further features in preferred embodiments of the invention described below, the valve is a gravitational check valve.

According to still further features in the described preferred embodiments, the device further comprises an air inflow port fluidly connected to the first lumen.

According to still further features in the described preferred embodiments, the air inflow port includes a selective membrane.

According to still further features in the described preferred embodiments, the second conduit includes a duckbill valve enabling one-way outflow of gasses from the vial.

According to still further features in the described preferred embodiments, the pliable reservoir is substantially inelastic.

According to still further features in the described preferred embodiments, the pliable reservoir is positioned under the vial when connected to the device.

According to still further features in the described preferred embodiments, the pliable reservoir is configured for being concentrically arranged around the vial.

According to still further features in the described preferred embodiments, the device further comprises a housing concentrically arranged around the pliable reservoir.

According to still further features in the described preferred embodiments, the device further comprises a third conduit for enabling one-way outflow of gasses from the pliable reservoir.

According to still further features in the described preferred embodiments the third conduit and the second conduit are fluidly connected.

According to still further features in the described preferred embodiments the pliable reservoir is pre-filled with a fluid have a volume substantially equal to that of the vial, and further wherein the second conduit is configured for allowing outflow of gas from the vial and prevent liquid outflow from the vial when a liquid in the vial exceeds a predetermined height.

According to another aspect of the present invention there is provided a system compensating for pressure changes in a vial comprising the device described hereinabove and a syringe adaptor assembly for preventing liquid contamination, the syringe adaptor assembly comprising: (i) a first portion having a third conduit connectable to a syringe; and (ii) a second portion being connectable to the first portion and having a fourth conduit connectable with the external port.

According to still further features in the described preferred embodiments, the third conduit and the fourth conduit are fluidly connected through a fifth conduit when the first portion and the second portion are connected.

According to still further features in the described preferred embodiments, the fourth conduit includes an elastic or plunger-cylinder reservoir for capturing liquid residue left therein when the first portion is disconnected from the second portion.

According to still further features in the described preferred embodiments, connection of the first portion to the second portion collapses the reservoir and further wherein disconnection of the first portion from the second portion expands the elastic reservoir.

According to still further features in the described preferred embodiments, the first portion and the second portion include spring-loaded or elastomeric sealing surfaces for creating a fluid-tight seal between the first portion and the second portion.

According to yet another aspect of the present invention there is provided a system for compensating for pressure changes in a vial comprising a syringe adaptor assembly including: (i) a first portion having a first conduit connectable to a syringe; and (ii) a second portion being connectable to the first portion and having a second conduit connectable to a vial; wherein the first or the second conduit includes an elastic reservoir for capturing liquid residue left therein when the first portion is disconnected from the second portion.

According to still further features in the described preferred embodiments connection of the first portion to the second portion collapses the reservoir and further wherein disconnection of the first portion from the second portion expands the reservoir.

According to still further features in the described preferred embodiments, a volume of the elastic reservoir is less than a volume of the vial.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 schematically illustrates the flow path between the vial and the pliable reservoir of the vial adaptor of the present invention.

FIG. 2 is an isometric view of one embodiment of a vial adaptor constructed in accordance with the teachings of the present invention.

FIGS. 3A-B are isometric views of another embodiment of a vial adaptor constructed in accordance with the teachings of the present invention.

FIGS. 4A-B are isometric views of yet another embodiment of a vial adaptor constructed in accordance with the teachings of the present invention.

FIG. 5 is a sectional view of a top portion of the vial adaptor of FIG. 2.

FIG. 6 is an isometric view showing the top of the vial adaptor of FIG. 2.

FIGS. 7A-B are isometric views of the components of a syringe adaptor constructed in accordance with the teachings of the present invention.

FIG. 8 is a cutaway view of an assembled syringe adaptor of FIGS. 7A-B showing the reservoir in a collapsed configuration. Region magnified shows conduit formed when the syringe adaptor sections are connected.

FIG. 9 is a cutaway view of an assembled syringe adaptor of FIGS. 7A-B showing the reservoir in an expanded configuration. Region magnified shows region of sealing between sections.

FIG. 10 illustrates the vial adaptor of the present invention connected to a dose preparation/delivery system via the syringe connector.

### DESCRIPTION OF THE PREFERRED EMBODIMENTS

The present invention is of vial adaptor and syringe connector, which can be used for the safe and contamination free reconstitution and transfer of vial medication and especially vials containing hazardous drugs.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Powdered medications are often supplied within rigid vials. The drug powder is reconstituted using a predetermined volume of a diluent withdrawn from a diluent vial or container. The diluent is injected into the drug vial via a syringe, the drug vial is swirled, and the reconstituted medication is withdrawn back into the syringe, which is then used to deliver the drug to the patient via the preferred method of administration.

Several vial adaptors have been devised in efforts of minimizing drug aerosolization during drug reconstitution and withdrawal. Although such vial adaptors address the aerosolization problem, they are complex to set up and operate and thus can lead to drug reconstitution and administration errors.

While reducing the present invention to practice, the present inventors have devised a vial adaptor that can prevent aerosolization and contamination of the environment and drug, as well as enable rapid withdrawal of the reconstituted drug with no appreciable formation of vacuum within the vial.

Thus according to one aspect of the present invention there is provided a device for compensating for pressure changes in a vial.

The device of the present invention includes a vial piercing/spiking element (e.g. needle) which includes two parallel conduits. The first conduit is configured for fluidly connecting the vial to an external port, such as a syringe port (e.g. Luer lock) and is used for introducing a diluent into the vial and for withdrawing the reconstituted drug from the vial. The second conduit is configured for enabling outflow of gasses from the vial (e.g. vapors of aerosolized diluent/drug) and includes a valve for preventing outflow of liquid (e.g. diluent, reconstituted drug solution) from the vial.

The device further includes a pliable reservoir, which is fluidly connected to the second conduit. The pliable reservoir has an expanded volume which is larger than a volume of the vial and is substantially non-elastic such that filling thereof with gas does not lead to buildup of pressure.

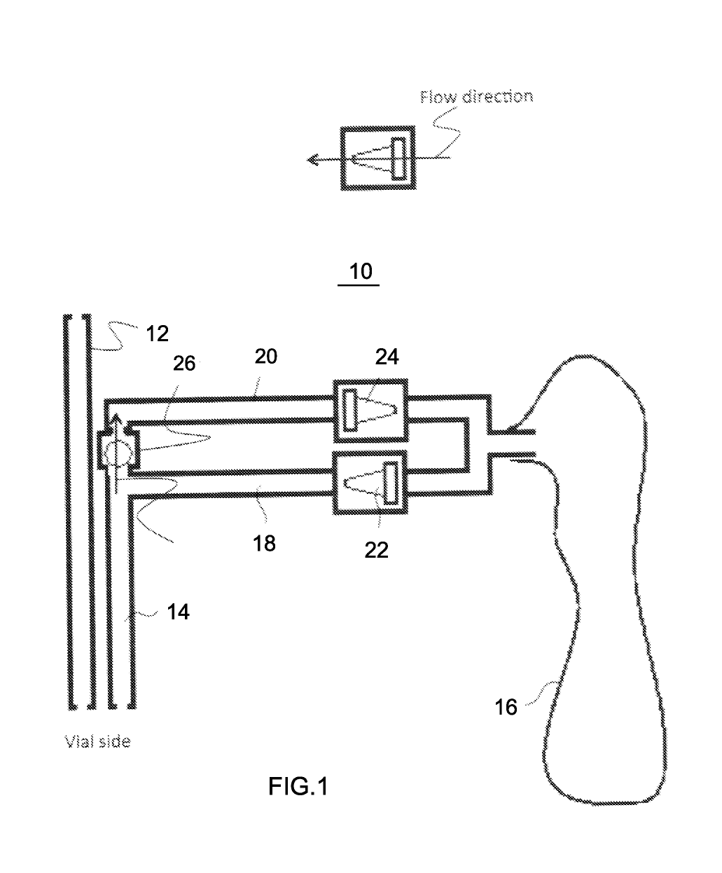

FIG. 1 schematically illustrates one embodiment of the device of the present invention (device 10) showing the path of fluid between the vial, external connector, and pliable reservoir.

Device 10 includes a spiking element (not shown in this Figure) having two fluid conduits, conduit 12 which fluidly connects the vial to an external device such as a syringe or an automated/semi-automated drug preparation and delivery system (e.g. a), and conduit 14 which fluidly connects the vial to a pliable reservoir 16.

In the embodiment shown in FIG. 1, conduit 14 includes a check valve 26 for preventing flow of liquid from the vial to pliable reservoir (e.g. when the vial is inverted). Such a valve can be a gravitational bead valve (shown in FIG. 1), or a gas permeable, liquid impermeable orifice/membrane.

In the embodiment shown in FIG. 1, conduit 14 fluidly communicates with pliable reservoir 16 via two conduits (18 and 20) each including a one way valve (22 and 24), e.g., a duckbill valve. Conduit 18 enables outflow of gas from pliable reservoir 16, while conduit 20 enables inflow of gas into pliable reservoir 16. Conduits 18 and 20 can be connected to pliable reservoir 16 via a single port (as shown in FIG. 1) or via separate ports (which can be co-positioned or spaced apart). It will be appreciated that inflow and outflow of gas can also be provided via a single contiguous conduit 14 which does not include a directional valve, or that inflow into the vial can be provided via a dedicated conduit fluidly connecting the environment with the vial through a filter for preventing microbial contamination and a valve (e.g. duckbill) or selective orifice for preventing outflow from the vial.

When used with a vial, pliable bag fills to accommodate vial-overpressure (when a diluent is introduced into the vial and the vial is swirled) and empties to accommodate for vacuum formed in the vial (when reconstituted medication is withdrawn). Thus, pliable reservoir 16 serves as a ‘gas capacitor’ for the vial, equalizing the pressure therein in over- and under-pressure situations.

Since pliable reservoir 16 is not elastic and has an internal volume larger than that of the vial, it can accommodate for vial overpressure without filling to a point of internal pressurization, i.e. it will accommodate vial vapors without filling to the point where internal pressure is created. Vapors trapped in pliable reservoir 16 can serve to compensate for vacuum formed in the vial during withdrawal of reconstituted drug or pliable reservoir 16 can be partially prefilled with sterilized air to accommodate for vial vacuum in cases where drug withdrawal can be the first operation.

The system generally illustrated in FIG. 1 is a fully closed system wherein vial contents do not come into contact with the environment. Such a configuration maintains drug sterility while protecting users from harmful vapors and aerosols that can escape from vial.

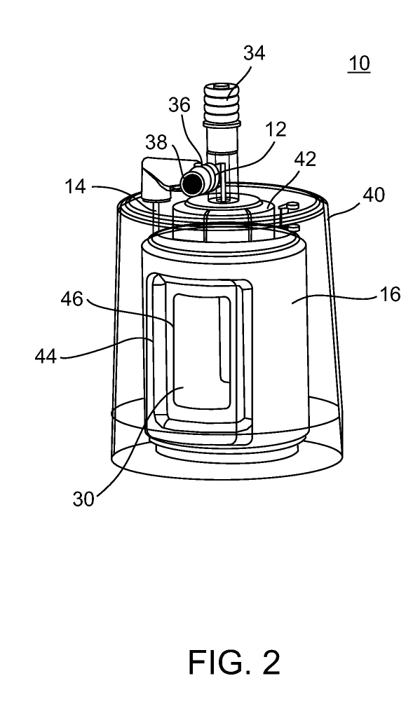

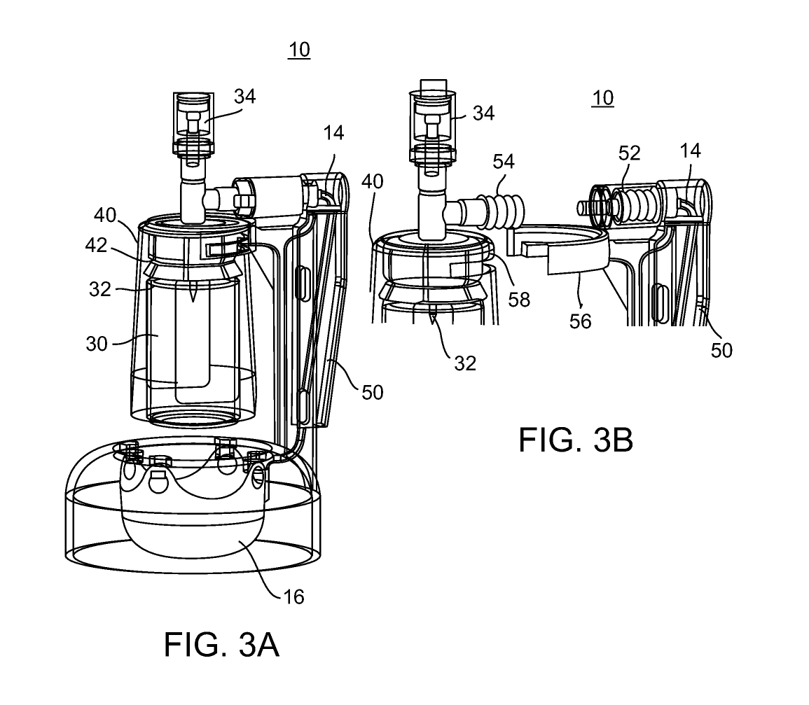

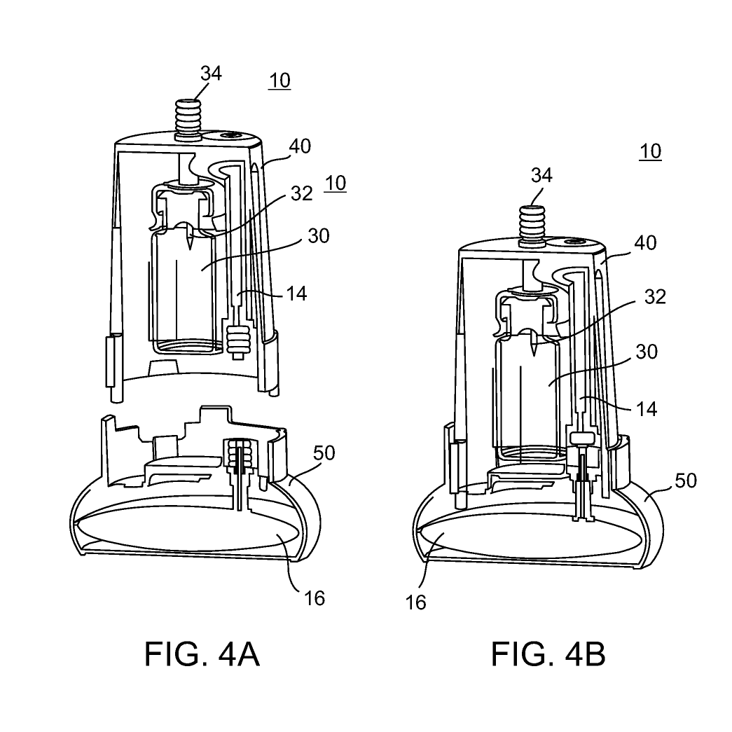

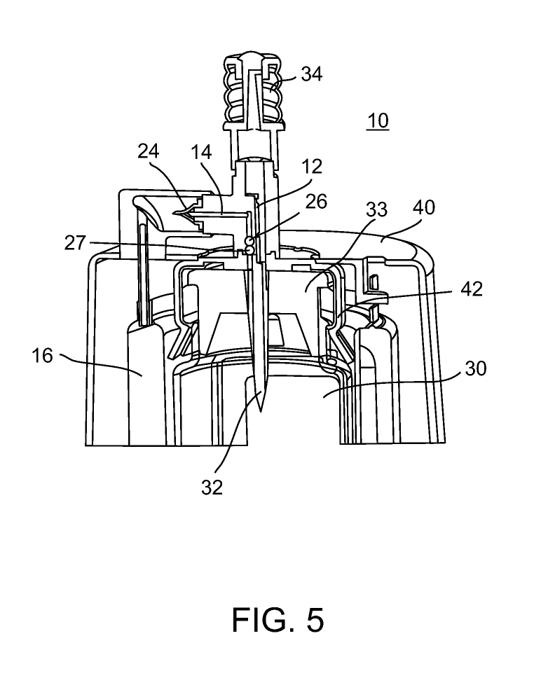

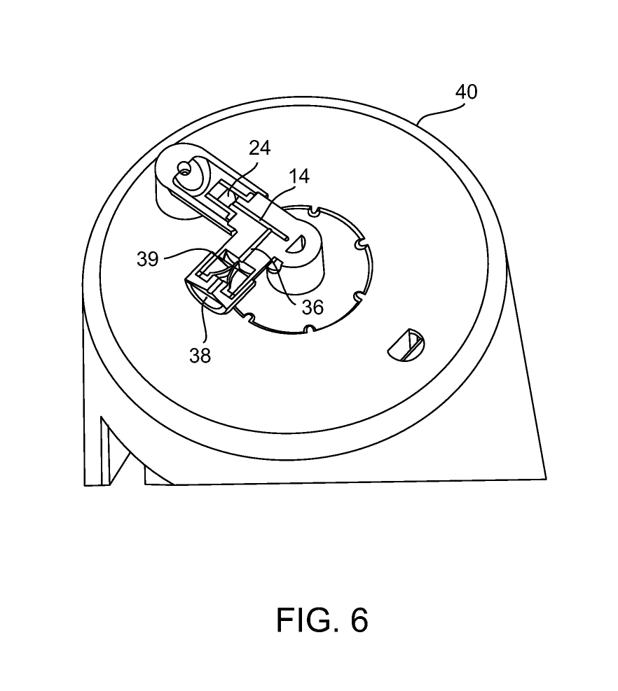

FIGS. 2-6 illustrate several embodiments of device 10 in greater detail. FIGS. 2-4b illustrate device 10 in which pliable reservoir 16 is arranged around vial 30 (FIG. 2) or below vial 30 (FIGS. 3a-4b). FIGS. 5-6 illustrate the fluid conduits of device 10 shown in FIG. 2.

The configuration exemplified by FIG. 2 is designed for small vials (2-10 ml); vial sterility is maintained via inlet filter, while contaminants remain in the pliable reservoir. In addition, since the pliable reservoir is positioned within the adaptor housing and around the vial, such a configuration is compact and easy to use (connection to vial is straightforward) and does not require elaborate setup steps.

The configuration exemplified by FIG. 3a is mainly designed for large vials (20-60 ml); it enables rapid disconnect from pliable reservoir and use with multiple vial sizes. In addition, when withdrawing medication from a disconnected vial, the syringe is not fluidly connected to the reservoir.

The conduit arrangement of the embodiment of FIG. 2 is shown in greater detail in FIG. 5.

Device 10 includes a vial piercing element 32 for piercing through a septum 33 of vial 30. Element 32 can be fabricated from an alloy (e.g. stainless steel) or a polymer and includes a beveled or double beveled tip for facilitating penetration of septum 33.

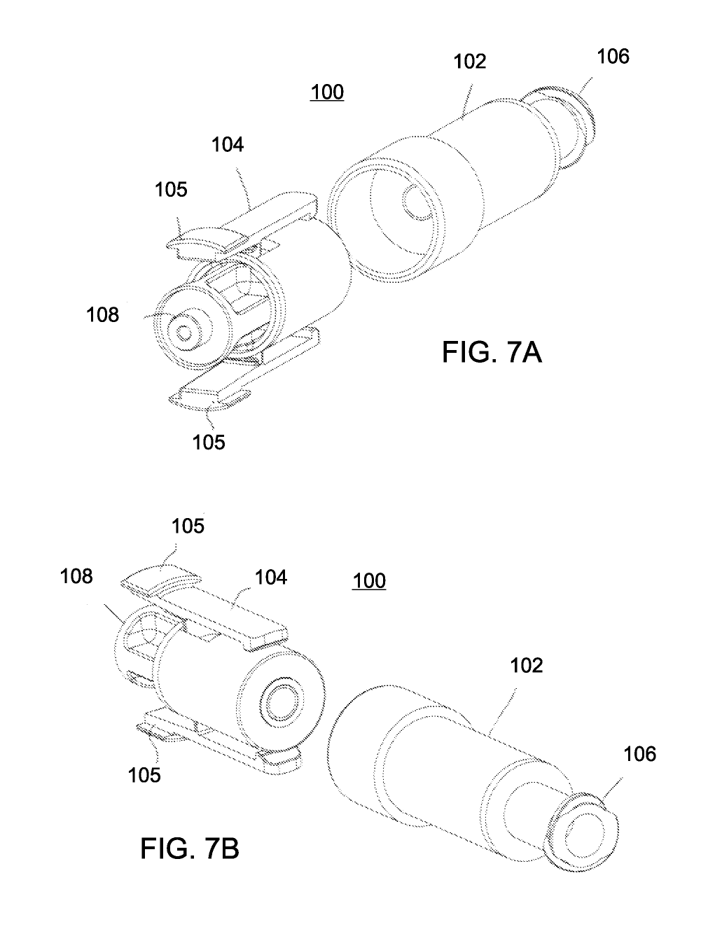

Element 32 is hollow and includes conduit 12 fluidly connecting vial 30 to a connector 34 (e.g. an anti-contamination syringe connector) and conduit 14 for fluidly connecting vial 30 to pliable reservoir 16 (concentrically arranged around vial 30 in this embodiment). Connector 34 is a chemo connector such as that described in FIGS. 7A-9.

The outer diameter (OD) of connector 34 can be in the range of 8-15 mm, and the length can be from 8 to 20 mm. The internal volume of pliable reservoir 16 is equal to or preferably greater than the vial/drug volume. For example, a device 10 used with a vial having a drug volume of 5 ml, includes a pliable reservoir 16 having an expanded volume of 5-10 ml. The shape of pliable reservoir 16 is typically determined by the vial connected to device 10. For example, in device 10 of FIG. 2, pliable reservoir 16 is shaped as a torus. Pliable reservoir 16 can be fabricated from any polymeric material, preferred are biocompatible, none permeable, weld-able laminate (multi layer) which are preferably non-compliant. Specific examples include polyethylene, polypropylene or the like. Pliable reservoir 16 can be fabricated by RF, US or Heat welding polymer sheets having a wall thickness of 50-250 microns.

Conduit 14 can include valve 26 for preventing flow of liquid (e.g. reconstituted drug or diluent) from vial 30 into pliable reservoir 16. Valve 26 can be a gravitational check valve or it can be a selective membrane/orifice (e.g. membrane—hydrophobic membrane, orifice—20-40 microns diameter, can implement a capillary element) which allows outflow of gas but not outflow of liquid from vial 30. Valve 26 shown in FIG. 5 is a ball-type valve. Ball 27 can be fabricated from an alloy and coated with rubber such that it has a specific gravity higher than that of liquid.

Conduit 14 can also include a one-way valve 24 (e.g. duckbill valve shown) for preventing backflow of vapor (and condensation) from pliable reservoir 16 to vial 30. Such a valve 24 can open under a gas pressure of 1 mm H₂O and close under a smaller back pressure (less than 1 mm H₂O).

To enable compensation for a vacuum formed in vial 30, device 10 of FIG. 5 also includes a vial inflow conduit 36 (shown in FIGS. 2 and 6). Conduit 36 fluidly connects vial 30 to the environment through a filter 38 (hydrophobic membrane with mesh of 0.5-10 microns or less—e.g. Tyvak paper) for preventing inflow of contaminants (e.g. bacterial, fungi, viruses) into vial 30. Conduit 36 can also include a one-way valve (e.g. duckbill valve) for preventing outflow from vial 30.

Compensation for a vacuum inside vial 30 can also be effected using the bi-flow path shown in FIG. 1 instead of conduit 36.

Device 10 also includes a housing 40 and a vial retaining clip 42 for aligning device 10 with vial 30 and for securing it to vial 30 during operation. Housing 40 is typically 5-20 mm taller and 5 to 30 mm wider (diameter) than the vial connected thereto. Housing 40 can be fabricated from polycarbonate or ABS and combinations thereof.

In the embodiment shown in FIGS. 2 and 5, housing 40 is arranged concentrically around pliable reservoir 16, which is in turn arranged around vial 30. In order to enable an operator to view the contents of vial 30 (to, for example, ascertain that a drug is reconstituted), housing 40 and pliable reservoir 16 each include a rectangular opening (44 and 46) forming a window through which the contents of vial 30 can be viewed.

FIGS. 3a-b illustrate an embodiment of device 10 that includes an assembly 50 for housing and connecting pliable reservoir 16 to housing 40. When connected to housing 40 (by interconnecting connectors 52 and 54), assembly 50 positions pliable reservoir 16 under vial 30. FIG. 3a illustrates housing 40 and assembly 50 in a connected state, FIG. 3b shows housing 40 and assembly 50 prior to connection illustrating clip 56 which mates with groove 58 for securing assembly 50 to housing 40.

A similar arrangement of pliable reservoir 16 is shown in FIGS. 4a-b. In this case, assembly 50 connects with a bottom face of housing 40 (FIG. 4a) and conduit 14 is positioned within the formed structure (FIG. 4b) which encases vial 30 at the top and pliable reservoir 16 at the bottom.

Device 10 can be used as follows. A syringe filled with 5 ml of a diluent is fitted onto connector 34 of device 10. The syringe plunger is pushed and the vial is filled with the diluent. Over pressure formed in vial 30 will immediately cause migration of vapors and liquid droplets into pliable reservoir 16 and as such, the internal pressure of the vial will remain constant during diluent filling. The vial is then swirled to reconstitute the drug, and device 10 with connected vial 30 are inverted to enabled withdrawal of the required dose (of reconstituted drug). Vacuum formed in vial 30 dues to withdrawal of the aspirated volume will be compensated via air inflow through filter 38 thus pressure within the vial will remain equal to that of the environment during drug withdrawal. Once the drug is withdrawn into the delivery syringe, vial 30 and attached device 10 can be discarded safely.

Device 10 of the present invention can be used to directly connect a syringe or automated/semi-automated drug preparation and delivery system to a vial or it can connect thereto through a ‘syringe’ adaptor.

When a syringe needle/cannula is withdrawn from a vial (following reconstitution and aspiration of a medicament), the vial septum (rubberized material) functions in trapping medicament coating the needle/cannula on the internal surface of the septum. However, such trapping is not complete and droplets of reconstituted medicament are oftentimes carried out from the vial on the external surface of the needle/cannula and contaminate the environment. Such a contamination can be a serious health hazard especially in the case of cytotoxic drugs.

In order to traverse this problem, the present inventors have devised a connector (also referred to herein as syringe connector) that can be connected to device 10 and a syringe (or any other drug withdrawal device/system) and be used to protect exposed surfaces from contamination.

In order to enable such functionality, the syringe connector includes two inter-connectable portions that provide a fluid path from vial to syringe when connected and include a collapsible reservoir capable of sucking residues present in the fluid path when the two sections are disconnected. Thus, following aspiration of a vial contents, disconnection of the connector sections traps any liquid that escaped from the vial and is present in the fluid path within the collapsible reservoir thereby preventing contamination of the environment.

FIGS. 7a-9 illustrates one embodiment of a syringe connector which is referred to herein as connector 100.

As is illustrated in FIG. 7a-b, connector 100 includes 2 sections, section 102 which is designed for connecting to a syringe or automated/semi-automated drug preparation and delivery system through a lock 106 such as a Luer lock and section 104 which connects to a vial (in which case port 108 can include a vial piercing element and vial clips) or to device 10. In some configurations of system 100, section 104 can be pre-connected to a vial adapter (or co-formed therewith), while section 102 can be pre-connected to a syringe or automated system.

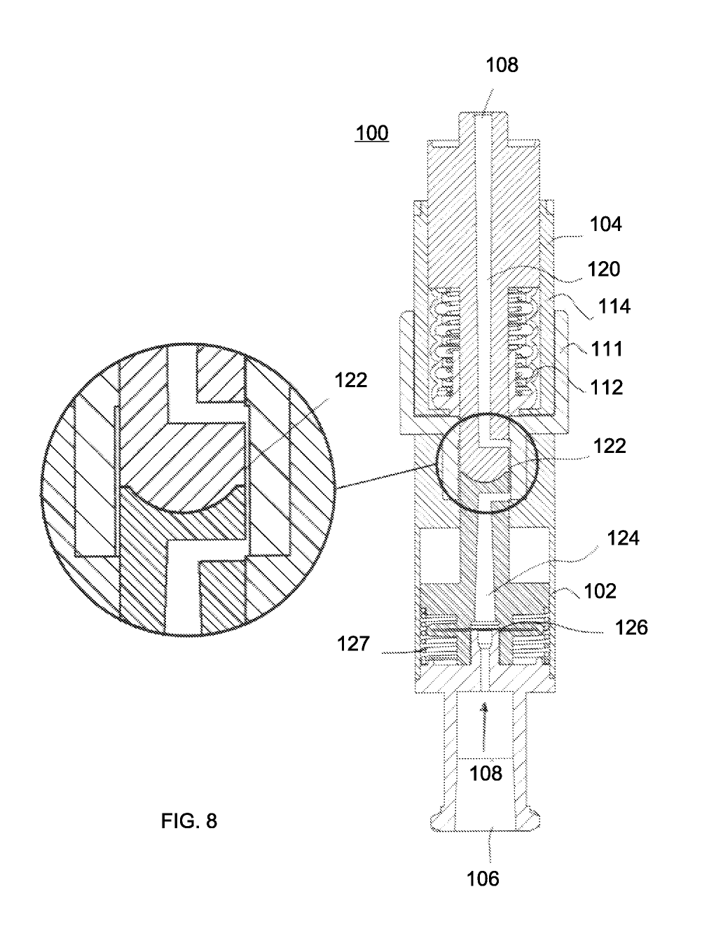

Sections 102 and 104 interconnect (and are secured via clips 105) to establish a fluid path from lock 106 to port 108. FIG. 8 illustrates the assembled connector 100, when sections 102 and 104 are connected and aligned, a fluid path 108 is formed.

Fluid path 108 is established via conduit 124, 122 and 120 when these conduits are connected (see FIG. 8, magnified view). Path 108 is preferably non-axial, conduit 122 is offset from conduits 120 and 124. Such an arrangement enables use of a radial sealing configuration (between sections 102 and 104) which requires alignment of sections 102 and 104 following attachment thereof, i.e. section 104 must be inserted and locked within section 104 to fluidly connect conduits 120, 122 and 124. This ensures that surfaces of sections 102 and 104 are sealed prior to opening of fluid path 108.

Section 104 is constructed from an outer housing 111 encasing an inner element 114 which can be translated in and out of housing 111 and can be completely disconnected therefrom (along with attached vial/adaptor). In order to ensure a tight seal between sections 102 and 104, element 114 includes a spring-loaded sealing gasket 112 which is compressed (FIG. 8) when element 114 is moved inward within housing 111 during connection and locking thereof to section 102. Alternatively, sealing can be effected via a radial elastomeric seal which is compressed when element 114 is moved inward.

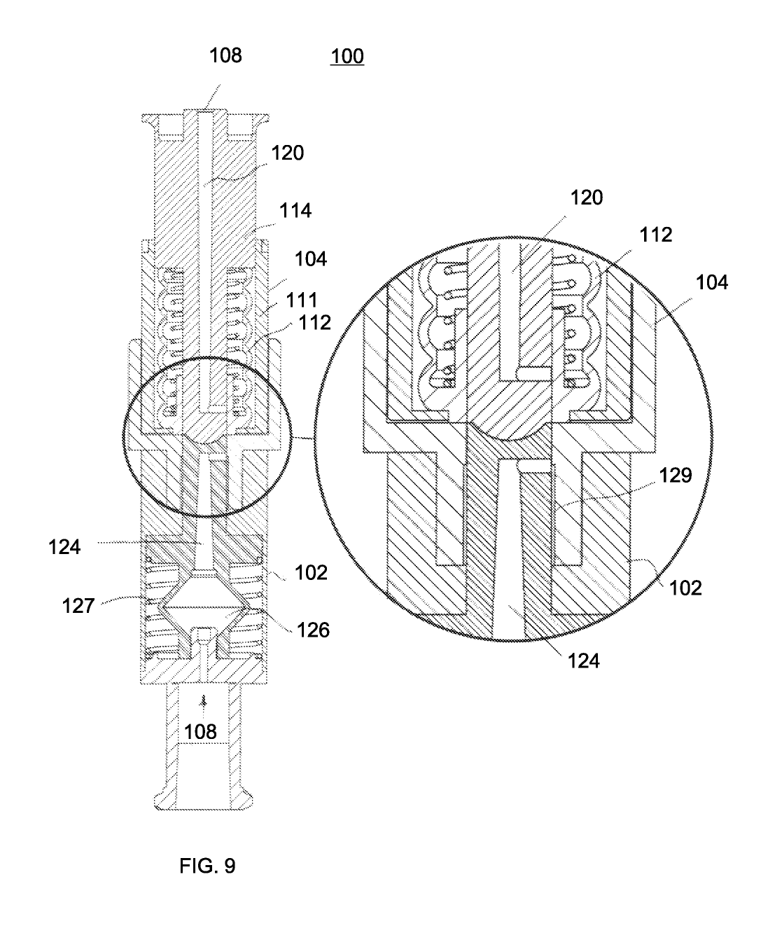

As is mentioned above, section 104 includes a conduit 120 which is capable of connecting to a conduit 124 formed when sections 102 and 104 are attached through conduit 122 (which forms a part of section 104). When sections 102 and 104 are connected conduit 124 fluidly connects to conduit 122. Moving element 114 inward within housing 111 and compressing gasket 112 locks element 114 in a position and seals sections 102 and 104. In addition, a cylindrically-shaped seal 129 (FIG. 9, magnified view) used around the region of contact between section 102 and element 114 ensures tight fitting contact surfaces and a tight seal and in addition serves to wipe residue off section 102 when removed from system 100 (along with the syringe).

Conduit 124 (of section 102) includes a collapsible reservoir 126 fabricated from an elastic material (e.g. silicone rubber or TPE) or a cylinder-plunger/bellows configuration. The volume of reservoir 126 can vary between 0.01 to 0.2 ml. Reservoir 126 forms a volumetric shape (roughly spherical, e.g. FIG. 9) and can be compressed (against elastic rebound forces—spring 127) to the substantially volume-less collapsed state shown in FIG. 8.

When sections 102 and 104 are connected and element 114 is pushed inward, reservoir 126 is forcibly collapsed to remove most of the air (or fluid/drug) trapped therein. In this state, fluid path 108 is established between conduit 124, 122 and 120 and fluid can flow from a vial to a connected syringe (under a fluid pulling force from the syringe). When element 114 is pulled out from housing 111, fluid path 110 is interrupted at connection between conduit 122 and 124 and reservoir 126 is no longer forcibly collapsed and thus it expands under its own elastic rebound forces or via expansion of spring 127 (a 0.1-1 N force) or expansion of the alternative mechanism described above (radial elastomeric seal). Expansion of reservoir 126 creates a vacuum pulling force in conduit 124 and sucks and traps any fluid remaining in fluid path 108.

Thus, when a syringe connected to element 114 is removed from section 102, any liquid contaminants remain trapped within section 102 and environmental contamination is avoided.

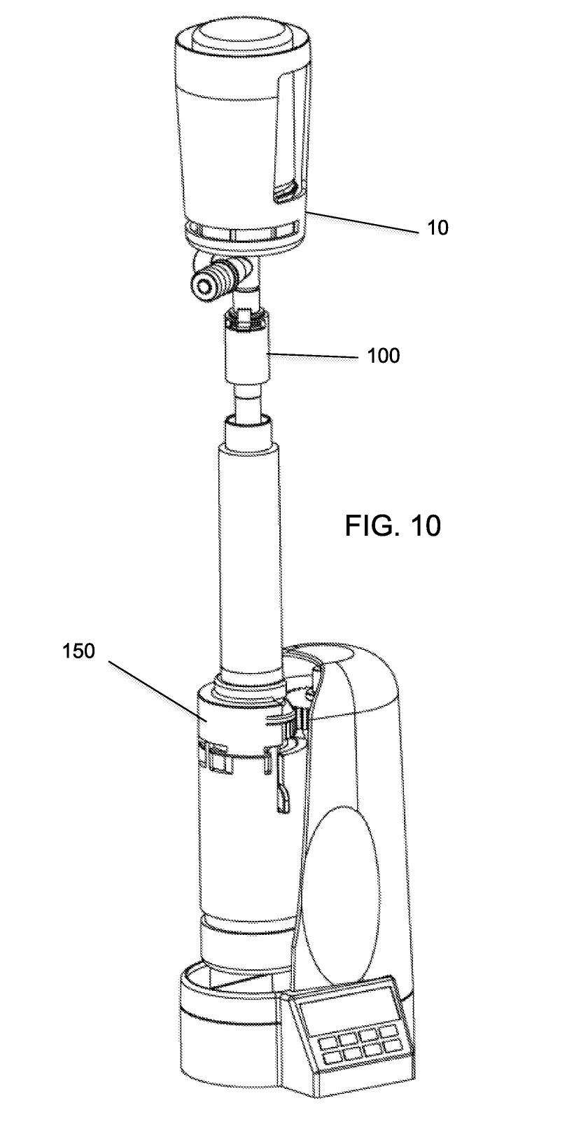

As is mentioned hereinabove, device 10 and connector 100 can each or both be used along with any Luer lock standard syringe or with an automated/semi-automated drug preparation and delivery systems (FIG. 10 illustrates a device 10 connected to a syringe-like dose preparation/delivery system 150 through connector 100). Such systems traverse limitations of manual syringe preparation and reduce overall medication errors providing a safer, more accurate way to prepare drugs from vials. The use of such systems is preferred when preparing and administering cytotoxic drugs since environmental contamination can pose a serious health hazard to the operator and incorrect dosing can be life threatening to the patient.

One preferred system that can be used with device 10 and/or connector 100 is described in U.S. Provisional Patent Application entitled System and Method for Preparing and Delivering a Medicament to the same inventors.

Briefly, such a system (which is shown in FIG. 10) includes a housing having a chamber for containing a liquid and a plunger movable within the chamber for drawing and dispensing liquid.

The plunger and housing are configured such that the plunger is movable via a drive mechanism capable of engaging a side of the plunger. Such a drive mechanism includes an electric motor having a drive gear which mates with a shaft gear fitted on the plunger shaft. Turning of the drive gear drives the plunger shaft up and down within the housing. Since the drive mechanism engages the side of the plunger shaft, the top of the plunger is free to be operated via a pushing/pulling force manually applied by an operator or applied via a spring or motor driver plunger driver.

Such a dual-drive, single chamber configuration provides several advantages including an ability to apply a drive force which is closer to the plunger head (that seals the chamber), thus minimizing forces that can displace (deflect) the plunger shaft from the movement axis, does not require use of external rails or drive guides, employs a static drive mechanism, only the plunger moves, enables more accurate and fine control over plunger withdrawal without requiring complicated drive mechanisms, can be used with a variety of plunger driving accessories and substantially reduces the bulk and footprint of the system.

It is expected that during the life of this patent many relevant automated/semi-automated drug preparation and delivery systems will be developed and thus the present invention is intended to operate with all such new technologies a priori.

As used herein the term “about” refers to±10%.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A device for compensating for pressure changes in a vial comprising:
(a) a first conduit for fluidly connecting the vial to an external port;
(b) a second conduit for enabling outflow of gasses from the vial, said second conduit having a valve for preventing outflow of liquid from the vial through said second conduit; and
(c) a pliable reservoir being fluidly connected to said second conduit and having an expanded volume larger than a fluid volume of the vial, said pliable reservoir being configured as a bag.

2. The device of claim 1, wherein said valve is a gravitational check valve.

3. The device of claim 1, further comprising an air inflow port fluidly connected to said first lumen.

4. The device of claim 3, wherein said air inflow port includes a directional valve.

5. The device of claim 1, wherein said second conduit includes a duckbill valve enabling one-way outflow of gasses from the vial.

6. The device of claim 1, wherein said pliable reservoir is substantially inelastic.

7. The device of claim 1, wherein said pliable reservoir is positioned under the vial when connected to the device.

8. The device of claim 1, wherein said pliable reservoir is configured for being concentrically arranged around the vial.

9. The device of claim 6, further comprising a housing concentrically arranged around said pliable reservoir.

10. The device of claim 1, further comprising a third conduit for enabling one-way outflow of gasses from said pliable reservoir.

11. The device of claim 10, wherein said third conduit and said second conduit are fluidly connected.

12. The device of claim 1, wherein said pliable reservoir is pre-filled with a fluid have a volume substantially equal to that of the vial, and further wherein said second conduit is configured for allowing outflow of gas from the vial and prevent liquid outflow from the vial when a liquid in the vial exceeds a predetermined height.

13. A system compensating for pressure changes in a vial comprising the device of claim 1 and a syringe adaptor assembly for preventing liquid contamination, said syringe adaptor assembly comprising:
(i) a first portion having a third conduit connectable to a syringe; and
(ii) a second portion being connectable to said first portion and having a fourth conduit connectable with said external port.

14. The system of claim 13, wherein said third conduit and said fourth conduit are fluidly connected through a fifth conduit when said first portion and said second portion are connected.

15. The system of claim 13, wherein said fourth conduit includes an elastic reservoir for capturing liquid residue left therein when said first portion is disconnected from said second portion.

16. The system of claim 15, wherein connection of said first portion to said second portion collapses said elastic reservoir and further wherein disconnection of said first portion from said second portion expands said elastic reservoir.

17. The system of claim 13, wherein said first portion and said second portion include spring-loaded sealing surfaces for creating a fluid-tight seal between said first portion and said second portion.

18. A system for compensating for pressure changes in a vial comprising a syringe adaptor assembly including:
(i) a first portion having a first conduit connectable to a syringe; and
(ii) a second portion being connectable to said first portion and having a second conduit connectable to a vial;
wherein said first or said second conduit includes an elastic reservoir for capturing liquid residue left therein when said first portion is disconnected from said second portion.

19. The system of claim 18, wherein connection of said first portion to said second portion collapses said elastic reservoir and further wherein disconnection of said first portion from said second portion expands said elastic reservoir.

20. The system of claim 18, wherein a volume of said elastic reservoir is less than a volume of said vial.
